(19) United States
(12) Patent Application Publication
(10) Pub. No.: US 2015/0043464 A1
(43) Pub. Date: Feb. 12, 2015

(54) METHOD, NETWORK NODE, COMPUTER PROGRAM AND COMPUTER PROGRAM PRODUCT FOR DETERMINING RESOURCE ALLOCATION BETWEEN DOWNLINK AND UPLINK

(71) Applicants: Qianxi Lu, Beijing (CN); Rui Fan, Beijing (CN); Yang Hu, Beijing (CN); Andreas Bergström, Vikingstad (SE)

(72) Inventors: Qianxi Lu, Beijing (CN); Rui Fan, Beijing (CN); Yang Hu, Beijing (CN); Andreas Bergström, Vikingstad (SE)

(73) Assignee: Telefonaktiebolaget L M Ericsson (publ), Stockholm (SE)

(21) Appl. No.: 14/381,875

(22) PCT Filed: Mar. 16, 2012
(86) PCT No.: PCT/CN2012/072476

§ 371 Date: Aug. 28, 2014

(51) Int. Cl. H04W 72/04

(52) U.S. Cl. CPC H04W 72/0493
USPC 370/329

(57) ABSTRACT

A method performed in a radio network for determining a resource allocation between downlink and uplink for use in a radio interface between a radio network node and at least one mobile communication terminal in a mobile communication network. The method includes determining content types of a first established channel over the radio interface and of a second established channel over the radio interface, respectively. Downlink-to-uplink indicators associated with the respective content types are obtained. Resource usages of the first established channel and the second established channel, respectively, are obtained. Using the downlink-to-uplink indicators and the resource usages, a combined downlink-to-uplink ratio is determined. The combined downlink-to-uplink ratio is applied. A corresponding network node, computer program and computer program product are also presented.

### TECHNICAL FIELD

The invention relates to a method, network node, computer program and computer program product for determining a resource allocation between downlink and uplink for use in a radio interface between a radio network node and one or more mobile communication terminals.

### BACKGROUND

In mobile communication networks, there is downlink (DL) traffic to mobile communication terminals from base stations and uplink (UL) traffic from mobile communication terminals to base stations. In mobile communication networks where defined time slots, frames or subframes can be allocated for either UL or DL, the allocation of resources between UL and DL needs to be configured to reflect expected traffic in the mobile communication network. Such configuration may for instance be necessary or beneficial in systems complying with GERAN (GSM (Global System for Mobile communications) EDGE (Enhanced Data Rates for GSM Evolution) Radio Access Network) or LTE (Long Term Evolution),

US-2009/0249153 presents a method for dynamic adjustment of downlink/uplink resource allocation ratio in a long-term evolution (LTE) time division duplex (TDD) system. The method includes replacing at least one of an uplink subframe and a downlink subframe with a mute subframe in a subframe pattern, indicating a first downlink/uplink resource allocation ratio. Thereafter, the mute subframe is replaced with either the uplink subframe or the downlink subframe to form another subframe pattern. The subframe pattern including the mute subframe is obtained from a lookup table, such that the replacing the mute subframe results in the other pattern. However, it is not shown an evaluation for triggering a change in the downlink/uplink resource allocation.

### SUMMARY

It is an object to provide a way to alter the allocation between UL and DL dynamically to let the allocation reflect at least some aspects of actual traffic.

According to a first aspect, it is presented a method for determining a resource allocation between downlink and uplink for use in a radio interface between a radio network node and at least one mobile communication terminal in a mobile communication network. The method comprises the steps, performed in a radio network node, of: determining content types of a first established channel over the radio interface and of a second established channel over the radio interface, respectively; obtaining downlink-to-uplink indicators associated with the respective content types; obtaining resource usages of the first established channel and the second established channel, respectively; determining, using the downlink-to-uplink indicators and the resource usages, a combined downlink-to-uplink ratio; and applying the combined downlink-to-uplink ratio. Using actual content as a base for determining a combined downlink-to-uplink ratio is a great improvement. This determination is close to actual needs for uplink and downlink resources.

The first established channel may be associated with the first mobile communication terminal and the second established channel is associated with a second mobile communication terminal, and the step of determining a combined downlink-to-uplink ratio may comprise determining a combined downlink-to-uplink ratio for a radio cell associated with both the first mobile communication terminal and the second mobile communication terminal. In other words, the method is applicable to determine a combined downlink-to-uplink ratio in situations where there are multiple mobile communication terminals in one cell.

The first established channel and second established channel may both be associated with a single mobile communication terminal. In other words, the method is applicable to determine a combined downlink-to-uplink ratio in situations where there are multiple channels for one mobile communication terminal in one cell.

The mobile communication network may comply with specifications of Long Term Evolution, LTE.

The mobile communication network may comply with specifications of EDGE, Enhanced Data Rates for GSM, Global System for Mobile communications, Evolution.

The step of determining content types may comprise determining the content types using deep packet inspection. Using deep packet inspection, the content determination can be performed without the use of headers or a configured content type for a channel. In other words, the deep packet inspection only inspects the content, providing a robust and low requirement content determination.

The step of obtaining downlink-to-uplink indicators may comprise reading a table of downlink-to-uplink indicators.

The method may further comprise the steps, prior to the step of obtaining downlink-to-uplink indicators, of: gathering statistics from traffic to obtain downlink-to-uplink indicators for a plurality of content types; and populating the table of downlink-to-uplink indicators using the statistics from traffic. In this way, the table of downlink-to-uplink indicators is populated from actual traffic, which reduces the need for manual configuration and may also more accurately reflect real traffic.

The table of downlink-to-uplink indicators may be preconfigured. Preconfiguration is simple and robust.

The step of determining a combined downlink-to-uplink ratio may comprise the steps of: calculating, using the downlink-to-uplink indicators and the resource usages, a calculated downlink-to-uplink ratio; and selecting, from a finite set of downlink-to-uplink ratios, a combined downlink-to-uplink ratio which best matches a calculated downlink-to-uplink ratio. In other words, only valid combined downlink-to-uplink ratios are determined.

Each one of the downlink-to-uplink indicators may be a downlink-to-uplink ratio.

A second aspect is a radio network node arranged to for determining a resource allocation between downlink and uplink for use in a radio interface between the radio network node and at least one mobile communication terminal in a mobile communication network. The radio network node comprises: a content type determiner arranged to determine content types of a first established channel over the radio interface and of a second established channel over the radio interface, respectively; a configuration reader arranged to obtain downlink-to-uplink indicators associated with the respective content types; a resource usage obtainer arranged to obtain resource usages of the first established channel and the second established channel, respectively; a ratio calculator arranged to determine, using the downlink-to-uplink indicators and the resource usages, a combined downlink-to-uplink ratio; and a ratio applier arranged to apply the combined downlink-to-uplink ratio.

The first established channel may be associated with the first mobile communication terminal and the second established channel may be associated with a second mobile communication terminal, and the ratio calculator may be arranged to determine a combined downlink-to-uplink ratio for a radio cell associated with both the first mobile communication terminal and the second mobile communication terminal.

The content type determiner may be arranged to determine the content type for the first established channel and the second established channel being associated with a single mobile communication terminal.

The mobile communication network may comply with specifications of Long Term Evolution, LTE.

The mobile communication network may comply with specifications of EDGE, Enhanced Data Rates for GSM, Global System for Mobile communications, Evolution.

The content type determiner may be arranged to determine content type using deep packet inspection.

The configuration reader may be arranged to read a table of downlink-to-uplink indicators.

The radio network node may further comprise: a statistics gatherer arranged to gather statistics from traffic to obtain downlink-to-uplink indicators for a plurality of content types; and a table populator arranged to populate the table of downlink-to-uplink indicators using the statistics from traffic.

The table of downlink-to-uplink indicators may be preconfigured.

The ratio calculator may be arranged to calculate, using the downlink-to-uplink indicators and the resource usages, a calculated downlink-to-uplink ratio, and select, from a finite set of downlink-to-uplink ratios, a combined downlink-to-uplink ratio which best matches a calculated downlink-to-uplink ratio.

Each one of the downlink-to-uplink indicators may be a downlink-to-uplink ratio.

A third aspect is a computer program for determining a resource allocation between downlink and uplink for use in a radio interface between a radio network node and at least one mobile communication terminal in a mobile communication network The computer program comprises computer program code which, when run on the network node, causes the network node to: determine content types of a first established channel over the radio interface and of a second established channel over the radio interface, respectively; obtain downlink-to-uplink indicators associated with the respective content types; obtain resource usages of the first established channel and the second established channel, respectively; determine, using the downlink-to-uplink indicators and the resource usages, a combined downlink-to-uplink ratio using the first downlink-to-uplink ratio, a calculated downlink-to-uplink ratio; and apply the combined downlink-to-uplink ratio.

A fourth aspect is a computer program product comprising a computer program according to the third aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIGS. 1A-B are schematic diagrams illustrating some variants of a mobile communication network where embodiments presented herein can be applied;

FIG. 2 is a schematic diagram of a packet used in communication between the mobile communication terminals and the radio network node of FIGS. 1A-B;

FIGS. 3A-B are flow charts illustrating embodiments of methods for determining a resource allocation between downlink and uplink for use in the radio interface of FIGS. 1A-B;

FIG. 4A is a schematic diagram showing some components of the network node of FIGS. 1A-B;

FIG. 4B is a schematic diagram showing functional modules of a processor of FIG. 4A; and

FIG. 5 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

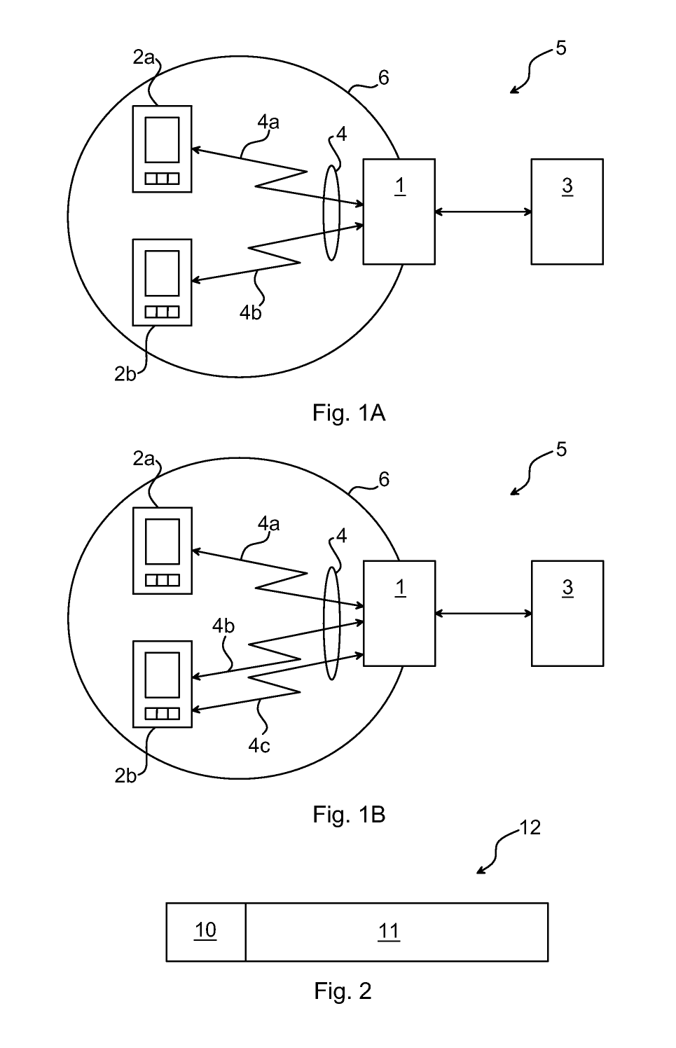

FIG. 1A is a schematic diagram illustrating a mobile communication network 5 where embodiments presented herein can be applied. The mobile communications network 5 comprises a core network 3 and one or more network nodes 1, here in the form of evolved Node Bs 1, also known as e-Node Bs or eNBs. The network nodes could also be a BTS (Base Transceiver Station) and/or a BSS (Base Station Subsystem). The network nodes 1 provide radio connectivity to a plurality of mobile communication terminals 2a-b. The term mobile communication terminal is also known as user equipment, mobile terminal, user terminal, user agent, etc.

The mobile communication network 5 can e.g. comply with LTE (Long Term Evolution) or with any one or a combination of EDGE (Enhanced Data Rates for GSM Evolution, GPRS (General Packet Radio Service), CDMA2000 (Code Division Multiple Access 2000), etc., as long as the principles described hereinafter are applicable.

The communication between each one of the mobile communication terminals 2a-b and the network node 1 occurs over a radio interface 4. In this example, the radio interface 4 comprises a first established channel 4a to the first mobile communication terminal 2a and a second established channel 4b to the second mobile communication terminal 2b. Established in this context means that the channels are set up and are usable for UL and/or DL traffic.

Both the first and the second mobile communication terminals 2a-b are located within a radio cell 6 of the network node 1.

The mobile communication network 5 of FIG. 1B is equivalent to the mobile communication network of FIG. 1A. One difference is that the second mobile communication terminal 2b has two established channels 4b-c over the radio interface 4 to the radio network node 1. Optionally, more channels could be established between the first and/or second mobile communication terminals 2a-b and the network node 1.

FIG. 2 is a schematic diagram of a packet 12 used in communication between the mobile communication terminals 2a-b and the radio network node 1 of FIGS. 1A-B over the established channels 4a-b. The packet 12 comprises a header section 10 and payload section 11. Using deep packet inspection, the payload section 11 and/or header section 10 are analysed to gather information about the content of the packet 12. For example, the content type of the packet 12 can be determined using deep packet inspection. Since data over a channel over the radio interface is transferred using packets, the content type of a channel can be determined using deep packet inspection of the packets over the channel. The packet 12 can e.g. be an IP (Internet Protocol) packet.

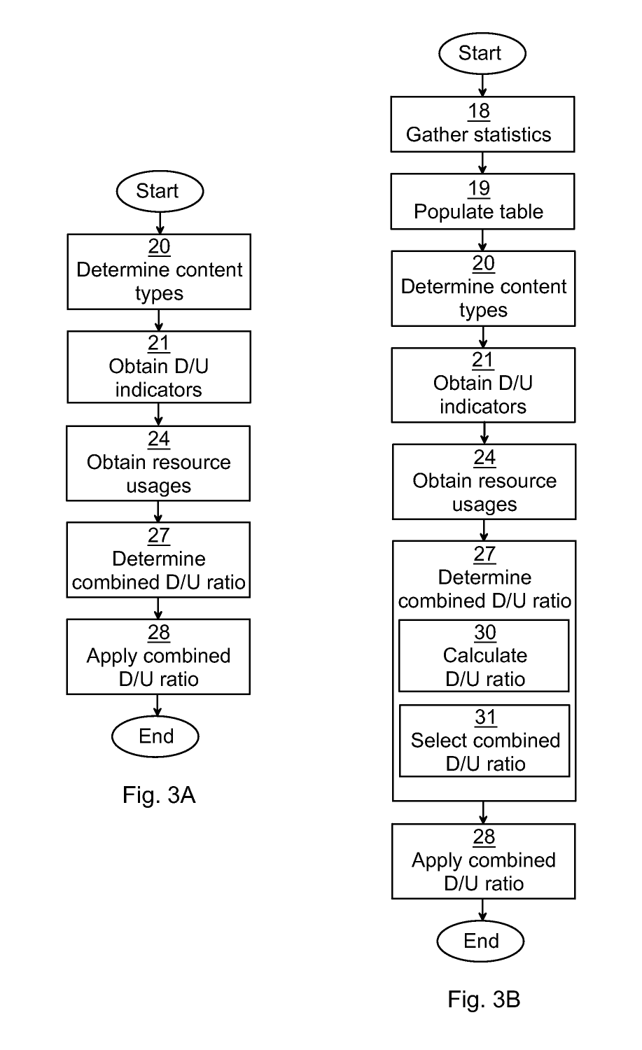

FIG. 3A is a flow chart illustrating an embodiment of a method for determining a resource allocation between downlink and uplink for use in the radio interface 4 of FIGS. 1A-B. This resource allocation can be expressed as a Downlink to Uplink ratio, abbreviated here as D/U ratio. Using references from both FIG. 3A and FIGS. 1A-B, the method is executed in the network node 1 of FIGS. 1A-B. This method can determine the D/U ratio for the situation shown in FIG. 1A or FIG. 1B. In other words, a combined D/U ratio can be determined for the radio cell 6 associated with both the first and second mobile communication terminals 2a-b. The combined D/U ratio can also be determined for a single mobile communication terminal with multiple established channels. The combined D/U ratio can also be determined for multiple mobile communication terminals within the same ratio cell 6, where one or more of the mobile communication terminals have a plurality of established channels.

In a determine content types step 20, content types of the established channels 4a-c are determined. The content type is a class of content and can e.g. be video streaming, audio streaming, web browsing, e-mail, instant messaging, P2P (peer-to-peer) file transfer, P2P video, social networking, software update, etc. The content type can optionally be determined using deep packet inspection of the packets of the respective established channels.

In an obtain D/U indicators step 21, D/U indicators associated with the respective content types of the channels are obtained. In other words, different content types can have different D/U indicators. For example, for video streaming, the ratio between downlink and uplink is greater than for e-mail. It is to be noted that, in this step, it is only the ratio between downlink and uplink that is obtained and not resource requirements as such. In other words, it is in this step irrelevant that e-mail typically uses significantly less resources and bandwidth compared to video streaming; it is only the relationship between downlink and uplink that is relevant. The D/U indicator indicates in some way the relation between uplink and downlink traffic on the channel and can e.g. be a D/U ratio or a U/D (Uplink to Downlink) ratio, portion of downlink traffic of all traffic on the channel, portion of uplink traffic of all traffic on the channel, etc.

Table 1 below shows some examples of D/U ratios:

TABLE 1
examples of D/U ratios

| Traffic type | Content type | D/U ratio |
|---|---|---|
| Bidirectional | P2P file sharing | 1.7 |
| Bidirectional | P2P video | 1.8 |
| Bidirectional | E-mail | 2.4 |
| Bidirectional | Instant messaging | 1.8 |
| Request/response | Social networking | 4.6 |
| Request/response | Web browsing | 10.1 |
| Mainly download | Software update | 32.3 |
| Mainly download | Audio streaming | 24.0 |
| Mainly download | Video streaming | 49.0 |

Table 1 comprises three traffic types: bidirectional, request/response and mainly download. The bidirectional traffic type comprises content types such as P2P file sharing, P2P video, E-mail, and instant messaging, where there is a significant amount of uplink traffic. The request/response traffic type comprises content types such as social networking and web browsing, where there is some uplink traffic, but most traffic is downlink. Finally, the mainly download traffic type comprises content types such as software update, audio streaming and video streaming, where the main traffic is downlink and typically only control messages are sent uplink.

The traffic types are not used in any other way than to logically group content types; the look up in the table is performed with content type as a key. In implementation, identifiers for the various content types can be used, rather than the text name of the content types. However, for clarity of explanation, the content types are written as text in Table 1.

As seen in Table 1, there is a great range in D/U ratios, ranging from 1.7 to 49. It is thus appreciated that considering each content type and the particular downlink/uplink characteristics of each content type when determining a combined D/U ratio is greatly beneficial to achieve an appropriate resource allocation between downlink and uplink.

It is to be noted that the list of content types in Table 1 is not exhaustive; the table can contain more or fewer content types. Moreover, the D/U ratio numbers are only examples and can vary considerably from the example values shown in practice.

In an obtain resource usages step 24, resource usages of the first and second established channels 4a-c are obtained. In this step, the resource usages for each established channel are thus also obtained. The resource usage can e.g. be traffic usage measured as bitrate.

In a determine combined D/U ratio step 27, a combined D/U ratio is determined, using the channel D/U indicators and the resource usages. This determination can use the principle of summing all downlink components, summing all uplink components and work out a ratio between the two.

In an apply combined D/U ratio step 28, the combined D/U ratio is applied by applying appropriate resource allocation between DL and UL. This implies that the total capacity in a cell or a multi-access transceiver is re-allocated with respect to the capacity in the UL and the DL direction, respectively. In a system were uplink and downlink communication directions share the same frequency channel on time slot basis this is performed by reallocating the ratio of slots in DL and UL communication directions, respectively. In a system were uplink and downlink communication directions have separate frequency channels, the reallocation is made by changing communication direction of one or more of the frequency channels.

FIG. 3B is a flow chart illustrating an embodiment of a method for determining a resource allocation between downlink and uplink for use in the radio interface 4 of FIGS. 1A-B. The steps of the method of FIG. 3A have equivalents in FIG. 3B and are only mentioned again when the methods differ in such a step.

In an initial optional gather statistics step 18, statistics from traffic is gathered to obtain channel D/U ratios for a plurality of content types. The statistics are gathered to get D/U indicators reflecting the actual traffic usage for particular content types. In this way, Table 1 can be populated using actual traffic use for the various content types.

In an optional populate table step 19, the table of channel D/U ratios is populated using the statistics from traffic. Alternatively or as a complement, the table of channel D/U ratios can be manually populated, whereby the table is preconfigured.

The steps 18-19 of gathering statistic and populate table can optionally be performed a significant time prior to the rest of the steps of the method. Alternatively, the steps of gathering statistic and populate table 18-19 can be performed in a separate thread from the rest of the method. Moreover, the steps 18-19 of gathering statistic and populate table may or may not be performed each time the rest of the steps are performed.

In the obtain D/U indicators step 21, the D/U ratios for the content types can be obtained from the table of channel D/U ratios, regardless if the table of channel D/U ratios is preconfigured or populated in the optional gather statistics step.

The determine combined D/U ratio step 27, may optionally comprise calculate D/U ratio step 30 and a select combined D/U ratio step 31.

In some situations, a calculated (combined) D/U ratio is initially calculated. However, this calculated D/U ratio may not be applied as the combined D/U ratio. Hence, optionally, a combined D/U ratio is selected from a finite set of allowable D/U ratios, where the combined D/U ratio is a D/U ratio within the finite set which best matches the calculated D/U ratio.

An example will now be presented to further illustrate the use of the methods of FIGS. 3A-B. This example determines the combined D/U ratio for the radio cell 6 of FIG. 1A, where there are two established channels 4a-b for two respective mobile communication terminals, 2a-b. References are made to the method of FIG. 3B.

Optionally, the gather statistics step 18 and the populate table step 19 have been performed previously to populate Table 1.

In the determine content type step 20, the content types of the established channels 4a-b are determined, e.g. using deep packet inspection. In this example, the content type of the first established channel 4a happens to be social networking and the content type of the second established channel 4b happens to be online audio.

In the obtain D/U indicators step 21, D/U indicators for the different content types are obtained. In this example, using Table 1 above, the content type for the first established channel is social networking, whereby the first D/U ratio is 4.6. The content type for the second established channel is audio streaming, whereby the second D/U ratio is 24.0.

In the obtain resource usages step 24, the actual resource usage for the two established channels are obtained. In this example, the resource usage, or bitrate, used for the first established channel happens to be 80 kbps and the resource usage, or bitrate, used for the second established channel happens to be 130 kbps.

In the determine combined D/U ratio step 27, the optimal D/U ratio if first calculated in the calculate D/U ratio step 30. In this example, the downlink load is first calculated by adding the contributions from the first and second established channels. So the combined downlink load Dcomb is calculated according to:

D_{comb}=80a×4.6b+130a×24.0b=3488ab (1)

where a is the unit of resource usage (kbps in this example) and b is the unit of the ratio (i.e. relative to one unit of upload)

The combined uplink load, Ucomb, is calculated in a similar way:

U_{comb}=80a×1b+130a×1b=201ab (2)

where b is 1 for both established channels.

A calculated D/U ratio is then calculated by dividing the combined downlink D_{comb} by the combined uplink U_{comb}:

D/U=2388ab/210ab≈16.61 (3)

The units a and b thus cancel out and the dimensionless ideal combined D/U ratio for the cell is calculated to about 16.61. However, the D/U ratio is selected between a number of configurable values. Consequently, in the select combined D/U ratio step 31, the D/U ratio which is closest to 16.61 is selected. In this example a combined D/U ratio is selected to be 5, which is the maximum.

The calculations above can be expanded to three or more established channels by adding terms for downlink and uplink in equations (1) and (2).

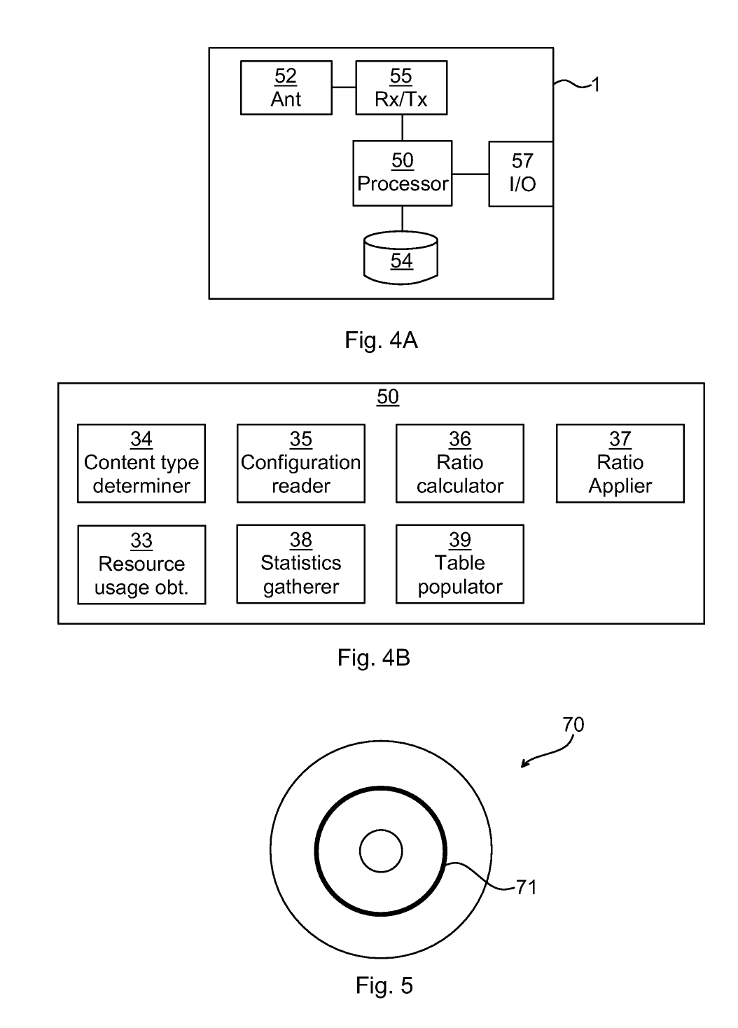

FIG. 4A is a schematic diagram showing some components of the network node of FIGS. A-B. A processor 50 is provided using any combination or one or more of a suitable central processing unit (CPU), multiprocessor, microcontroller, digital signal processor (DSP), application specific integrated circuit etc., capable of executing software instructions stored in a computer program product 54, e.g. in the form of a memory. The processor 50 can be configured to execute the method described with reference to FIGS. 3A-B above.

The computer program product 54 can be a memory or any combination of read and write memory (RAM) and read only memory (ROM). The memory also comprises persistent storage, which, for example, can be any single one or combination of magnetic memory, optical memory, solid state memory or even remotely mounted memory.

The network node 1 further comprises an I/O interface 57 for communicating with the core network and optionally with other network nodes.

The network node 1 also comprises one or more transceivers 55, comprising analogue and digital components, and a suitable number of antennas 52 for radio communication with mobile communication terminals within one or more radio cells.

Other components of the network node are omitted in order not to obscure the concepts presented herein.

FIG. 4B is a schematic diagram showing functional modules of the processor 50 of FIG. 4A. The modules can be implemented using software such as a computer program executing in the processor 50. Optionally, one or more of the modules are implemented using hardware or a combination of hardware and software. The modules correspond to the methods as described with reference to FIGS. 3A-B above.

A content type determiner 34 is arranged to determine the content types of the first and second established channels (see e.g. 4a-b of FIG. 1A), e.g. using deep packet inspection.

A configuration reader 35 is arranged to obtain D/U indicators, such as D/U ratios, associated with the respective content types. The D/U indicator can be read from a table, such as table 1 above. The table can be preconfigured or dynamically generated and updated using an optional statistics gatherer 38.

A resource usage obtainer 33 is arranged to obtain resource usages of the first established channel and the second established channel, respectively.

A ratio calculator 36 is arranged to determine, using the D/U indicators and the resource usages, a combined D/U ratio.

Optionally, the first established channel is associated with the first mobile communication terminal 2a and the second established channel is associated with a second mobile communication terminal 2b, as depicted in FIG. 1A. The ratio calculator 36 is then arranged to determine the combined D/U ratio for the radio cell associated with the two mobile communication terminals 2a-b.

Alternatively, the first established channel and the second established channel are associated with a single mobile communication terminal, e.g. like the established communication channels 4b-c of FIG. 1B.

The ratio calculator 36 may be arranged to calculate, using the D/U indicators and the resource usages, a calculated D/U ratio. The calculated D/U ratio is then used to select, from a finite set of D/U ratios, a combined D/U ratio which best matches a calculated D/U ratio.

A ratio applier 31 is arranged to apply the combined D/U ratio.

An optional statistics gatherer 38 can be arranged to gather statistics from traffic to obtain D/U indicators for a plurality of content types.

When there is a statistics gatherer 38, an optional table populator 39 can be arranged to populate the table of D/U indicators using the statistics from the statistics gatherer.

FIG. 5 shows one example of a computer program product 70 comprising computer readable means. On this computer readable means, a computer program 71 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied as a memory of a device, such as the computer program product 54 of FIG. 4 or in an external memory such as a USB (Universal Serial Bus) memory. While the computer program 71 is here schematically shown as a track on the depicted optical disk, the computer program can be stored in any way which is suitable for the computer program product.

The invention has mainly been described above with reference to a few embodiments. However, as is readily appreciated by a person skilled in the art, other embodiments than the ones disclosed above are equally possible within the scope of the invention, as defined by the appended patent claims.

1-24. (canceled)

25. A method for determining a resource allocation between downlink and uplink for use in a radio interface between a radio network node and at least one mobile communication terminal in a mobile communication network, the method comprising the steps, performed in a radio network node, of:
determining content types of a first established channel over the radio interface and of a second established channel over the radio interface, respectively;
obtaining downlink-to-uplink indicators associated with the respective content types;
obtaining resource usages of the first established channel and the second established channel, respectively;
determining, using the downlink-to-uplink indicators and the resource usages, a combined downlink-to-uplink ratio; and
applying the combined downlink-to-uplink ratio.

26. The method according to claim 25 wherein the first established channel is associated with the first mobile communication terminal and the second established channel is associated with a second mobile communication terminal, and
the step of determining a combined downlink-to-uplink ratio comprises determining a combined downlink-to-uplink ratio for a radio cell associated with both the first mobile communication terminal and the second mobile communication terminal.

27. The method according to claim 25, wherein the first established channel and second established channel are both associated with a single mobile communication terminal.

28. The method according to claim 25, wherein the step of determining content types comprises determining the content types using deep packet inspection.

29. The method according to claim 25, wherein the step of obtaining downlink-to-uplink indicators comprises reading a table of downlink-to-uplink indicators.

30. The method according to claim 29, further comprising the steps, prior to the step of obtaining downlink-to-uplink indicators, of:
gathering statistics from traffic to obtain downlink-to-uplink indicators for a plurality of content types; and
populating the table of downlink-to-uplink indicators using the statistics from traffic.

31. The method according to claim 25, wherein the step of determining a combined downlink-to-uplink ratio comprises the steps of:
calculating, using the downlink-to-uplink indicators and the resource usages, a calculated downlink-to-uplink ratio; and
selecting, from a finite set of downlink-to-uplink ratios, a combined downlink-to-uplink ratio which best matches a calculated downlink-to-uplink ratio.

32. A radio network node arranged to for determining a resource allocation between downlink and uplink for use in a radio interface between the radio network node and at least one mobile communication terminal in a mobile communication network, the radio network node comprising:
a content type determiner arranged to determine content types of a first established channel over the radio interface and of a second established channel over the radio interface, respectively;
a configuration reader arranged to obtain downlink-to-uplink indicators associated with the respective content types;
a resource usage obtainer arranged to obtain resource usages of the first established channel and the second established channel, respectively;
a ratio calculator arranged to determine, using the downlink-to-uplink indicators and the resource usages, a combined downlink-to-uplink ratio; and
a ratio applier arranged to apply the combined downlink-to-uplink ratio.

33. The radio network node according to claim 32, wherein the first established channel is associated with the first mobile communication terminal and the second established channel is associated with a second mobile communication terminal, and
the ratio calculator is arranged to determine a combined downlink-to-uplink ratio for a radio cell associated with both the first mobile communication terminal and the second mobile communication terminal.

34. The radio network node according to claim 32, wherein the content type determiner is arranged to determine the content type for the first established channel and the second established channel being associated with a single mobile communication terminal.

35. The radio network node according to claim 32, wherein the content type determiner is arranged to determine content type using deep packet inspection.

36. The radio network node according to claim 32, wherein the configuration reader is arranged to read a table of downlink-to-uplink indicators.

37. The radio network node according to claim 36, further comprising:
a statistics gatherer arranged to gather statistics from traffic to obtain downlink-to-uplink indicators for a plurality of content types; and
a table populator arranged to populate the table of downlink-to-uplink indicators using the statistics from traffic.

38. The radio network node according to claim 36, wherein the table of downlink-to-uplink indicators is preconfigured.

39. The radio network node according to claim 32, wherein the ratio calculator is arranged to calculate, using the downlink-to-uplink indicators and the resource usages, a calculated downlink-to-uplink ratio, and select, from a finite set of downlink-to-uplink ratios, a combined downlink-to-uplink ratio which best matches a calculated downlink-to-uplink ratio.

40. The radio network node according to claim 25, wherein each one of the downlink-to-uplink indicators is a downlink-to-uplink ratio.

41. A computer program for determining a resource allocation between downlink and uplink for use in a radio interface between a radio network node and at least one mobile communication terminal in a mobile communication network, the computer program comprising computer program code on a non-transitory computer readable medium which, when run on the network node, causes the network node to:
determine content types of a first established channel over the radio interface and of a second established channel over the radio interface, respectively;
obtain downlink-to-uplink indicators associated with the respective content types;
obtain resource usages of the first established channel and the second established channel, respectively;
determine, using the downlink-to-uplink indicators and the resource usages, a combined downlink-to-uplink ratio using the first downlink-to-uplink ratio, a calculated downlink-to-uplink ratio; and
apply the combined downlink-to-uplink ratio.

42. A computer program product comprising a computer program according to claim 41, and a non-transitory computer readable medium on which the computer program is stored.
